(19) United States
(12) Patent Application Publication
(10) Pub. No.: US 2014/0231055 A1
(43) Pub. Date: Aug. 21, 2014

(54) Heat Exchanger Produced from Laminar Elements

(71) Applicant: Vacuum Process Engineering, Inc., Sacramento, CA (US)

(72) Inventor: Carl Schalansky, Sacramento, CA (US)

(73) Assignee: Vacuum Process Engineering, Inc., Sacramento, CA (US)

(21) Appl. No.: 14/273,008

(22) Filed: May 8, 2014

Related U.S. Application Data
(63) Continuation-in-part of application No. 13/226,051, filed on Sep. 6, 2011.

(51) Int. Cl. B23P 15/26; F28F 3/08

(52) U.S. Cl. CPC B23P 15/26; F28F 3/08
USPC 165/166; 29/890.039

(57) ABSTRACT

The present invention provides a heat exchanging device, formable into a three dimensional configuration. The heat exchanger device may be of the heat sink type, a dual fluid type, or virtually any other as may be desired. The heat exchanger device comprises a main body which is formable into a three dimensional shape and has a plurality of individual subunit elements adapted to form a plurality of stacked heat exchanging units. The individual subunits have surface configurations which are adapted to allow fluid flow. The present invention also describes devices, methods of making a heat exchanging device and/or methods of attaching external components to the heat exchanging device without damaging internal structures.

### REFERENCE TO RELATED APPLICATION

In accordance with 37 C.F.R. 1.76, a claim of priority is included in an Application Data Sheet filed concurrently herewith. Accordingly, the present invention claims priority as a continuation-in-part of U.S. patent application Ser. No. 13/226,051, filed Sep. 6, 2011, entitled “HEAT EXCHANGER PRODUCED FROM LAMINAR ELEMENTS”. The content of which the above referenced application is herein incorporated by reference in its entirety.

### FIELD OF THE INVENTION

This invention is directed toward the field of heat exchangers, to a heat exchanging device, and methods of making a heat exchanging device which can form complex, three dimensional geometrical configurations; and to a method of constructing a heat exchanging device formable into a predetermined configuration which allows for manifold attachment or manifold closure that minimizes damage to existing internal structure.

### BACKGROUND OF THE INVENTION

Often, an operating machine or electronic component or an industrial process system generates waste heat in the course of its normal operation. If this waste heat is not removed, degraded performance or damage to the system may result. Frequently, the operating temperature of a system needs to be precisely maintained in order to obtain optimal performance. For example, it is often desirable to cool the sensors used in thermal imaging cameras to improve the sensitivity of the imager. Further, analytical instruments may require that the sample to be analyzed be presented to the instrument at a precisely controlled temperature.

Heat exchangers permit heat to be removed or added to the sample as may be desired. A common type of heat exchanger is referred to as a “heat sink.” A heat sink typically transfers heat between a solid object and some fluid media, which may a liquid, air or other gasses. Computer microprocessors frequently employ heat sinks to draw heat from the processor to the surrounding air, thereby cooling the microprocessor. Fins are often provided to increase the surface area of the heat sink to the air thereby increasing the efficiency of the heat sink. Such a heat sink could also comprise a closed fluid system. For example, a recirculating liquid coolant might be used to transfer heat from that portion of the heat sink in contact with the heat-generating device to a remotely located radiator. The heat sink could be of a single or a two-phase fluid design.

Another type of heat exchanger employs at least two fluids. In this type of heat exchanger, heat is transferred from a first fluid to a second fluid without direct contact between the fluids. For example, a fluid-to-fluid heat exchanger for a blood processing machine may employ heated water to warm the blood to the proper temperature. The blood circulating path is completely separate from that of the water circulating path and dilution or contamination of the blood is thus avoided. Other types of heat exchangers include those designed to recover waste heat from systems that produce excess heat, for example, a passenger compartment heater that derives heat from an automobile engine. Regardless of the type of heat exchanger, it is desirable to obtain a high degree of heat transfer efficiency.

Several factors affect the efficiency of heat exchangers. To maximize efficiency it is desirable that the following situations occur:

1. The thermal-conductivity of the materials that must conduct heat should be high so as to permit maximum heat transfer.

2. Heat transfer surface areas should be large and have features that efficiently transfer heat from the fluid to solid members.

3. Heat transfer members should, in general, have large cross-section lateral to heat transfer path.

4. Fluid flow should be efficient with minimal pressure loss with fluid dynamics that provide efficient heat transfer. Other important criteria are known and will not be detailed here.

In dual-fluid heat exchangers, a variety of flow relationships may be employed relative to the two fluids. In a counter-flow relationship, the two fluids flow primarily in opposite directions to one another. In a cross-flow relationship the two fluids primarily flow at right angles to one another.

Some basic heat exchanger configurations include: shell and tube, plate, plate and fin, and pillow plate. The shell and plate exchangers are the most widely used, basic heat exchanger configuration. This configuration provides a comparatively large ratio of heat transfer area to volume and weight, and is relatively easy to construct. This type of heat exchanger consists of a shell with a bundle of tubes inside it. One fluid runs through the tubes, and another fluid flows over the tubes (through the shell) to transfer heat between the two fluids. The set of tubes may be composed by several types of tubes, such as plain or longitudinally finned. The instant invention is provides for a configuration with extremely large heat transfer capability and is an improvement over the existing art.

The plate heat exchanger uses metal plates to transfer heat between two fluids. This has a major advantage over a conventional heat exchanger in that the fluids are exposed to a much larger surface area because the fluids spread out over the plates.

A plate-fin heat exchanger is designed to use plates and finned chambers to transfer heat between fluids. It is often categorized as a compact heat exchanger to emphasize its relatively high heat transfer surface area to volume ratio. A plate-fin heat exchanger is made of layers of corrugated sheets separated by flat metal plates, typically aluminum, to create a series of finned chambers. Separate hot and cold fluid streams flow through alternating layers of the heat exchanger and are enclosed at the edges by side bars. Heat is transferred from one stream through the fin interface to the separator plate and through the next set of fins into the adjacent fluid. The fins also serve to increase the structural integrity of the heat exchanger and allow it to withstand high pressures while providing an extended surface area for heat transfer.

A pillow plate exchanger is typically constructed using a thin sheet of metal spot-welded to the surface of another thicker sheet of metal. The thin plate is welded in a regular pattern of dots or with a serpentine pattern of weld lines. After welding the enclosed space is pressurized with sufficient force to cause the thin metal to bulge out around the welds, providing a space for heat exchanger liquids to flow, and creating a characteristic appearance of a swelled pillow formed out of metal.

Regardless of the design, the basic function of a heat exchanger is to convey heat from one location to another. While some heat exchangers are relatively simple, such as that of a cast aluminum heat sink for a semiconductor, others are quite complex and require a variety of sophisticated manufacturing processes. The means and process of the instant invention overcome many of the shortcomings of previous designs particularly with respect to the handling and fixturing of heat exchanger components.

Diffusion bonding or brazing of a stack of planar members is a common technique to produce heat exchangers. These processes permit the construction of very intricate internal structures. In the case of a heat exchanger or chemical reactor produced by these means, it is necessary to provide ports so the heat exchanging fluids or reactant chemicals can be hermetically ported into and out of the device proper. Often these ports comprise a manifold that serves to effectively couple fluids and/or gases into and out of the heat exchanger or reactor. While these manifolds and/or ports may be constructed at the time the stack assembly is bonded, several problematic issues may arise during this process. Diffusion bonded, including the use of a transient liquid phase, or brazed assemblies can be damaged by the relatively high heat required to attach manifolds by welding. The advantage of this process is that heat generated during the welding process is not readily transmitted to the critical regions of the brazed or diffusion bonded assembly. Additionally, this process permits manifold inlets and outlets to be safely added to the heat exchanger after other processes are completed. Adding the manifold inlets and outlets after the brazing or bonding phase has been completed can offer several benefits.

When manifolds and/or ports are constructed at the time the stack assembly is bonded, issues relating to internal washing, for example a cleaning wash, or if the part is to be wash coated to impart a film of alumina or other materials to the inner surfaces of a heat exchanger or reactor, can arise. In a similar manner, another washing process, such as a nitric acid wash, may be carried out to passivate the interior wetted surfaces of the part. If the inlet and outlet manifolds are present at the time of this wash, the flow through the system can be greatly diminished. This results in inhibiting thorough washing. Additionally, there may be regions in the assembly that cannot be adequately washed due to occlusion by the manifold/port features. The manifolds may also comprise “dead volumes” that prevent a uniform application of wash material, thorough washing or thorough wash coating material removal. By attaching the inlet and outlet manifolds after other processes have been completed, the wash flow path through a heat exchanger or reactor may be shortened and restriction of the flow path minimized, thereby ensuring a more uniform and consistent distribution of the coating material on the inside surfaces of the component or more thorough washing of the internal structure of the part.

While it can be advantageous to attach the manifolds after the stack bonding process, great care must be taken when attaching manifolds to a previously brazed assembly. Heat involved in the welding or brazing process can damage the stack proper. One form of damage occurs when the attachment process re-melts the braze material holding the stack together. This can lead to discontinuities in the brazed joints resulting in leaks through the structure. Additionally, if the braze material of the stack reaches the liquidus temperature, it can flow into delicate passages and block flow paths. If this re-melt is severe, the planar members of the structure may migrate relative to one another and distort the structure. The migration may result in closing off passages or, alternatively, creating internal leaks between passages.

Another problem results from the potential formation of “virtual leaks,” or dead spaces into which fluid can slowly, and undesirably, ingress and egress from the main flow path(s). Even if the members of the structure do not migrate, the assembly can be damaged by excess heat. This damage may take the form of surface oxidation or chemical and/or metallurgical alteration. These oxides or other surface contaminants may block delicate passageways within the structure or render the structure chemically inconsistent with its intended use. The structure of the stack proper may also be damaged due to stresses induced by excess heating which can result in warping, distortion or even cracking. This problem can be particularly bothersome if the weld is situated at the mutual convergence of multiple planar members, which is often the case when welding a manifold closure plate onto a manifold, in which case the welds may be situated at the juncture of two or more typically mutually perpendicular planar elements. Sometimes referred to as a “triple point” in the case of three planar elements, welds made in these regions are prone to many of the issues previously cited. Since welding frequently occurs at the region where these planes intersect, substantial heat from manifold welding can introduce high stresses at these points. The heat affected zone of the weld is relatively small in comparison to the bulk of the material, causing large localized thermal expansion. Detrimentally high temperatures may be applied at this point while attempting to obtain good weld penetration that is necessary to assure an acceptable weld within the rest of the structure. If this situation occurs near the stack proper, portions of the stack can be severely damaged during the welding process.

In some situations, additional elements are added to the bonding or brazing materials. For example, phosphorus is sometimes added to braze and transient phase diffusion bonding alloys to depress their melting point. If phosphorus containing alloys are used in transient liquid phase bonding (TLP), or other brazing processes used to bond the stack, cracking can be an issue due to localized excess phosphorus content. In this case, it is common for cracks to appear in regions that have been subjected to the high heat of welding. The presence of boron or carbon can also cause similar cracking in some materials. “Time-at-temperature” will permit local concentrations of phosphorus or carbon to diffuse through the part to reach progressively lower levels, but this may still be insufficient to prevent cracking during traditional high temperature welding processes. The present invention includes a method of constructing a heat exchanging device to overcome such problems.

### DESCRIPTION OF THE PRIOR ART

Devices for dissipating heat are known in the art. For example, U.S. Pat. No. 3,457,988 describes a heat sink member using fin members which are mounted and spaced apart from each other on the heat sink. U.S. Pat. No. 3,537,517 describes a heat dissipating assembly which uses a stack of parallel cooling fins which are spaced apart and mounted on a peripheral surface of a core member. U.S. Pat. No. 5,375,655 describes an improved heat sink apparatus that includes a base plate and a plurality of finned assembly units. The finned assembly units are described as being constructed and arranged in an abutting relationship and off-set from each other to provide a fluid pathway. U.S. Pat. Nos. 5,535,816, 5,794,684, 5,900,670, 6,712,128, 6,861,293, 7,597,13, 7,760,506, and U.S. Patent Application 2001/0037875 describe variations to heat sink and/or air flow generating devices that dissipate heat utilizing individual, stacked heat exchanging elements.

Devices which do not utilize individually formed stacked plates are also known in the prior art. For example, U.S. Pat. No. 6,199,624 describes a heat sink having heat exchanging sections defined by a thermally conductive sheet folded into alternating ridges and troughs to define generally parallel finned spaces. U.S. Pat. No. 6,698,511 describes a device which is described as improving the thermal efficiency for heat transfer from an electronic device. The device is described as containing a fin array having regions with fins having different density and some fins having a curvilinear shape. These devices, however, are configured in the same manner as the traditional stacked plate configurations, and accordingly cannot assume complex three dimensional shapes.

Non heat sink related devices using plate-like configurations are known in the art. For example, U.S. Pat. No. 6,537,506 describes a chemical reactor for forming products. The chemical reactor is described as including simple plate structures which are stacked together to form a plurality of layers. U.S. Pat. No. 6,192,596 describes a device designed for micro-channel fluid processing. U.S. Pat. No. 5,888,390 illustrates a multilayer integrated assembly for handling fluid functions. The device is described as containing complementary micro-fluid structures which are etched within the surface of a foldable substrate.

### SUMMARY OF THE INVENTION

The present invention provides a heat exchanging device formable into a three dimensional configuration. The heat exchanger device may be of the heat sink type, a dual fluid type, or virtually any other as may be desired. The heat exchanger device comprises a main body which is formable into a three dimensional shape and has a plurality of individual subunit elements adapted to form a plurality of stacked heat exchanging units. The individual subunits have surface configurations which are adapted to allow fluid flow. The surface configurations may be formed, for example, by removing a portion of the surface, either completely or to a specified depth, thereby yielding a window, or removed region in which fluid may flow. The exact geometry of these regions may take any form desired. By preparing a plurality of these elements and stacking them, a complex, three-dimensional geometry may be obtained. Because of the modular nature of the instant invention, a great variety of heat exchanger types and variations may be produced with little or no tooling change.

In an illustrative embodiment, a method of constructing a heat exchanging device formable into a three dimensional configuration which allows for manifold attachment or manifold closure that does not damage any existing heat exchanging device internal structure is described. The present invention provides for a remote welding process that uses a series of thin wing walled potions and cantilevered plates that are formed, preferably during the initial bonding of the stack. These walls and plates are configured in a manner that permits the attachment of manifolds by brazing or welding, while protecting the stack proper from damage. The process avoids the necessity of making the weld immediately adjacent to the structurally and metallurgically sensitive stack, thereby protecting it from excessive heat.

Accordingly, it is an objective of the instant invention to provide a heat exchanging device which can form complex, three dimensional geometrical configurations.

It is a further objective of the instant invention to provide a heat exchanging device comprising a plurality of individual subunit elements which are adapted to fold onto adjacent subunit elements to form complex, three dimensional configurations.

It is yet another objective of the instant invention—to provide a heat exchanging device which is modular in nature.

It is a still further objective of the instant invention to provide a heat exchanging device which can form complex, three dimensional configurations with little or no tooling change.

It is a further objective of the instant invention to provide a heat exchanging device which can be easily and economically produced.

It is yet another objective of the instant invention to provide a three-dimensional heat exchanging structure from a plurality of simple laminar elements.

It is a further objective of the instant invention to provide a complex, three-dimensional heat exchanging device which incorporates functional gradient members.

It is yet another objective of the instant invention to provide a complex, three-dimensional heat exchanging device which incorporates enhanced surface area features.

It is a still further objective of the invention to provide a complex, three-dimensional heat exchanging device which incorporates heat transfer enhancement features.

It is a further objective of the instant invention to provide a heat exchanging device which is highly scalable, permitting the production of heat exchangers of any size.

It is yet another objective of the instant invention to provide a process that provides for high temperature welding or brazing of manifold attachment or manifold closure to a heat exchanging device that does not damage the internal structures of the device.

It is a further objective of the instant invention to provide a process that avoids the necessity of making a weld immediately adjacent to a structurally and metallurgically sensitive heat exchanging stack, thereby protecting it from excessive heat.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of a heat exchanging device prior to folding or stacking together;

FIG. 2 is a perspective view of the heat exchanging device illustrated in FIG. 1 and shown in the process of being folded;

FIG. 3 is a perspective view of the heat exchanging device that has been folded, compressed and bonded;

FIG. 4 is a perspective view of the heat exchanging device showing inlet/outlet manifold;

FIG. 5 is a plan view of an alternative embodiment of the heat exchanging device;

FIG. 6 is a plan view of an alternative embodiment of the heat exchanging device;

FIG. 7 is a perspective view of an alternative embodiment of the heat exchanging device prior to folding and stacking;

FIG. 8 is a section view of the heat exchanging device illustrated in FIG. 7;

FIG. 9 is a section view of the heat exchanging device illustrated in FIG. 7, showing structures acting as functional gradient;

FIG. 10A is a plan view of an alternative embodiment of the heat exchanging device having subunit elements of unequal lengths and fold region positioning;

FIG. 10B is a perspective view of the heat exchanging device illustrated in FIG. 10A and shown in a folded configuration;

FIG. 10C is a plan view of an alternative embodiment of the heat exchanging device having subunit elements of unequal lengths where the large subunit elements contain multiple fold regions to form a support structure;

FIG. 10D illustrates an alternative embodiment of the heat exchanging device structured to function as a liquid to gas cooled heat sink;

FIG. 10E illustrates an alternative embodiment of the heat exchanging device structured to function as a gas cooled heat sink;

FIG. 11 is a perspective view of a subunit element of an alternative embodiment of the heat exchanging device showing surface configurations which are useful for liquid—liquid fluid flow;

FIG. 12 is a perspective view of a plurality of differently sized subunit elements and having surface configurations containing functional gradients which are useful for gas-liquid fluid flow.

FIG. 13 is a perspective view of an alternative embodiment of the heat exchanging device;

FIG. 14 is a perspective view of the heat exchanging device illustrated in FIG. 13, illustrating an alternative attachment of the end plates;

FIG. 15 is a perspective view of the heat exchanging device illustrated in FIG. 13, illustrating a special weld feature;

FIG. 16A is a perspective view of an illustrative embodiment of an upper plate;

FIG. 16B is a perspective view of an illustrative embodiment of a lower plate;

FIG. 17 is a top view of a subunit element used to construct the heat exchanging device illustrated in FIG. 13;

FIG. 18 is a perspective view of the subunit element illustrated in FIG. 17.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

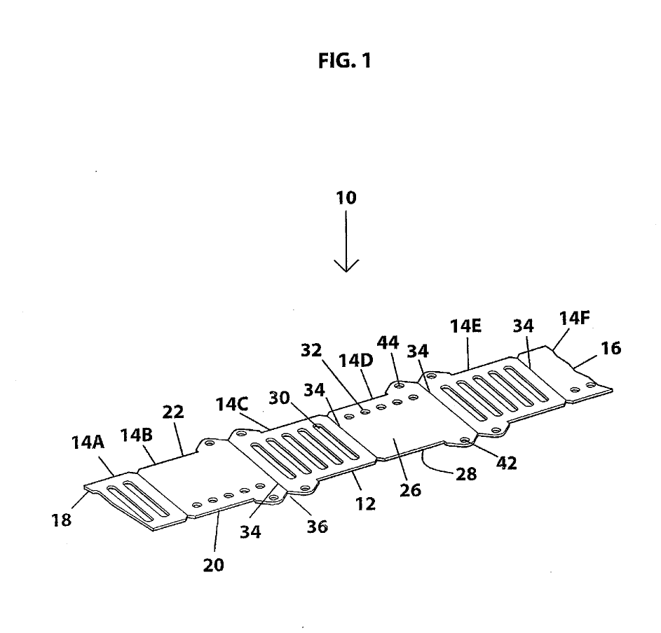

Referring to FIG. 1, a perspective view of an illustrative embodiment of a heat exchanging device, referred to generally as 10, is illustrated. The heat exchanging device 10 contains a main body 12, preferably made of a laminar material and/or other materials that exchange heat such as aluminum or copper, comprising individual subunit elements 14A, 14B, 14C, 14D, 14E, and 14F, collectively 14. While the illustrative embodiment is shown having 6 subunit elements, the heat exchanging device may have fewer or greater than six. The number of subunits which make up the heat exchanging device 10 is generally referred to as “SUEₙ” where “SUE” refers to subunit element designation and “n” equals any number greater than 1. Accordingly, a heat exchanging device where the “SUEₙ” is SUE₁₀, the device consists of the main body 12 comprising 10 subunits.

The main body 12 contains a first end 16, a second end 18, a first side edge 20, and a second, opposing side edge 22. Each of the subunit elements 14A, 14B, 14C, 14D, 14E, or 14F contains a first surface 26 and a second surface 28. Each of the first surfaces of the individual subunit elements together defines the first surface of the heat exchanging device. Each of the second surfaces of the individual subunit elements together defines the second surface of the heat exchanging device.

The main body 12 contains a plurality of individual subunit elements, which when folded form a plurality of stacked heat exchanging units. Each of the individual subunit elements may contain surface configurations adapted to allow fluid flow and exchange of heat. Adjacent subunits may or may not have identical feature patterns as each adjacent subunit need not be unique to its immediate neighbor. For example, 3-4 subunit elements having the same configuration may be adjacently positioned to form a particular height or passage.

Alternatively, adjacent subunits may have different feature patterns. For example, subunit element 14 may contain one or more slots 30 which extend through the first surface 26 to the second surface 28, and one or more apertures 32 which extend through the first surface 26 to the second surface 28. Alternatively, the slots 30 and apertures 32 may extend through the first surface 26 to a specified depth. If the subunit elements contain a plurality of slots 30, such slots can be arranged in a parallel fashion, at right angles, or any other arrangement. The apertures 32 are shown arranged at or near the first edge 20 or opposing edge 22 and arranged in a row. The apertures may, however, be arranged in any fashion along any portion of the first surface 26 and/or second surface 28. The slots 30 or apertures 32 may be formed by punching, machining, fine-blanking, laser cutting, water-jetting, grinding, photo-chemical machining, ion-milling, abrasive blasting or any other suitable process. Preferably, the slots 30 and apertures 32 are aligned in such a manner that promotes the flow of a fluid through the heat exchanging device 10 in an efficient manner.

The heat exchanging device 10 may contain a plurality of fold regions, illustrated herein as fold lines 34. Such fold lines 34 allow each of the subunits to bend or fold relative to an adjacent subunit element. The fold lines 34 may be formed through semi-perforations, coining processes, or through other known mechanisms. To aid in the folding or bending of the subunits, the heat exchanging device 10 may contain one or more fold initiators 36. The fold initiators 36 may be formed by punching, machining, fine-blanking, laser cutting, water-jetting, grinding, photo-chemical machining, ion-milling, abrasive blasting or any other suitable process may take a variety of forms, such as, but not limited to, notches, grooves, slits or other forms that serve to promote bending of one or more portion of the main body 12 and/or the individual subunit elements. If the fold initiator 36 is constructed of a grooved form such that only a portion of the depth of the main body 12 is removed, the fold initiator may transverse the entire width of the main body. If the fold initiator 36 is constructed as a slot, hole or notch design, the slots, holes or notches would typically be of a discontinuous nature but still would exist predominately along the desired fold line.

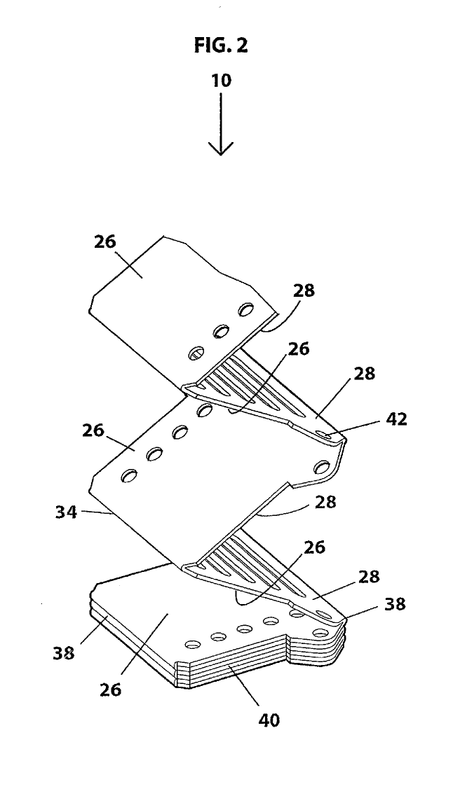

One of the unique aspects of the instant invention is the fact that the heat exchanging device 10 is designed as a single unit which is capable of folding to form unique three dimensional geometries or shapes. Such a device provides a mechanism to produce heat exchangers that can be shaped according to odd geometries and can be produced in a cheaper manner that other devices that need to have specific shapes. Not having to handle individual subunit elements in forming the overall shape provides a distinct advantage when compared to conventional construction using individual sheets. Handling individual sheets can be time consuming and labor intensive and often results in misaligned configurations. Because the individual subunits are part of a larger main body arranged in predetermined sequences, the subunits cannot be aligned out of sequence. Referring to FIG. 2, the heat exchanging device 10 is illustrated in the process of being folded to form a three dimensional shape of a square having a T shaped portion. To form the desired shape, a user simply folds the device 10 along fold lines 34 such that each one subunit bends relative to an adjacent subunit. The user continues to bend each of the subunits along the fold lines 34 in a Z-shaped pattern until the desired shape is accomplished. To provide a uniform shape, each subunit may be constructed so that each subunit has a shape which is a mirror image of each adjacent subunit so that when one folds onto another, the combination forms the same shape as the individual units, thereby maintaining the shape of the final configured device. Although not illustrated, the folded and configured heat exchanging device 10 may be secured together to other folded and configured devices to form additional configurations. Although illustrated in a parallel manner, the fold lines 34 need not be arranged in this manner. Fold lines 34 may be arranged in a non-parallel arraignment to provide irregularly shaped structures, such as helical or twisted shapes.

The first surface 26 of each subunit element may be a bondable surface so that the second surfaces 28 of adjacent subunit elements may be joined together over one or more portions of each of the surfaces. The bondable surface my take the form of a clean, smooth surface that may be bonded by diffusion bonding, including transient liquid-phase diffusion bonding. Alternatively, the bondable surface may comprise a brazing alloy that can be melted to join together adjacent sections of the subunit elements. The brazing alloy may comprise a thin sheet of alloy or other material that is interleaved between adjacent the first surfaces and/or the second surfaces of the subunit elements. The brazing alloy may also comprise a paste or powder that is applied to either one of both of the first faces to be bonded. Further, the brazing alloy may be in the form of cladding or a plated layer on the laminar material, which when heated, bonds the adjacent layers. Brazing may also be accomplished by “dip-brazing” or other suitable processes as long as the process does not significantly interfere with desirable fluid path geometries. In lieu of or in addition to bonding adjacent layers by diffusion bonding or brazing, any suitable welding process may be employed to bond adjacent layers without the use of a brazing alloy.

Alternately, successive layers of the subunits elements may be joined at their periphery, thereby defining fold edges 38 and laminate edge 40, by brazing or welding. The fold edges 38 preferably comprise a hermetic seal. Welding processes may include, but are not limited to, laser welding, electron-beam welding, ultrasonic welding, resistance welding, press welding, friction welding, any of the processes referred to as “arc-welding,” such as gas metal arc welding (GMAW), metal inert gas (MIG) welding, tungsten inert gas welding (TIG) or the like. The above laminar element bonding or welding processes assume that the heat exchanging device 10 is comprised of metal or a metal alloy. The structure could however be comprised, without being limiting, of other materials such as ceramics, polymers glasses or composites. Adhesives such as epoxies, cyanoacrylates, silicones or other materials may be employed to bond adjacent layers and/or seal the periphery of the heat exchanging device 10 instead of or in addition to brazing and/or welding.

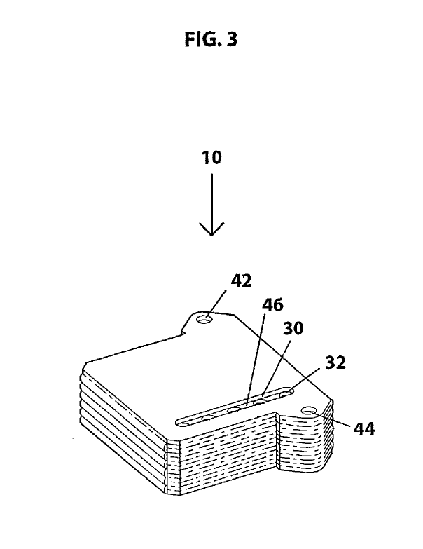

Registration features, illustrated herein as holes 42 and 44 positioned on each of the subunit elements may be employed to aid in alignment of the subunit elements during and/or after the folding process. Registration feature 42 and may also be employed as a mechanism to fix or secure the device 10 during brazing, welding or any other process including mounting the finished product. Other elements, such as pins or other guides, may be employed as part of the securing process and designed to interact with registration features 42 and 44 (see FIG. 3) to either temporary or permanently align the parts. In addition, the holes 42 and 44 may provide a point for optical inspection to ensure proper alignment of the structure elements.

FIG. 3 illustrates the configuration of the heat exchanging device 10 once all of the subunit elements have been folded and secured as described above. The heat exchanging device 10 is designed to allow the flow of fluids, either gases or liquids, to flow from the external environment into the device's internal environment. The design of each of the individual subunits can be adapted to provide various degrees of heat exchange. Referring back to FIG. 1, the plurality of subunit elements are arranged so that the subunit elements are arranged in an alternating pattern of adjacent subunit elements having apertures 32, see for example subunit element 14B, 14D, and those having slots 30, see for example subunit elements 14A, 14C, 14E. In addition, for those subunit elements having apertures 32, see for example subunit elements 14B, 14C, or 14F, the positioning of the apertures 32 alternate on subsequent subunits. The apertures 32 associated with subunit element 14C are arranged on the side of the subunit near the first side edge 20, while the apertures 32 for the subunit element 14D are positioned on the opposing second side edge 22. Subunit element 14F contains the apertures 32 positioned on the right side. Having the subunits configured in this manner, provides the folded device 10 the capability to direct fluid flow into the apertures 32 on one side, through the slots 30, and out through the opening 32 along the opposite side.

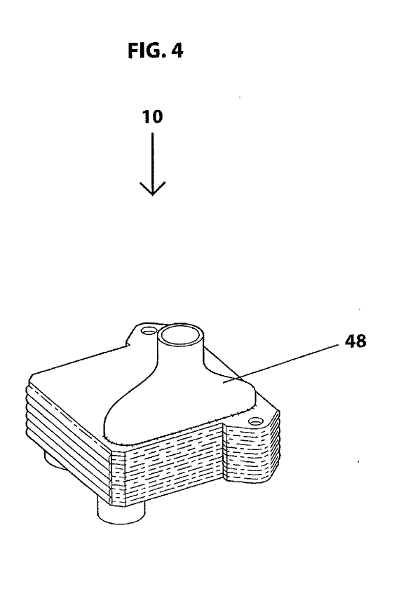

Depending on the intended application, a manifold 46 may be employed to provide a hydraulic connection to a plurality of passages that are formed by the slots 30, the apertures 32, or other voids within the structure, see FIG. 3. Referring to FIG. 4, a manifold adapter 48 is shown engaged with the heat exchanging device 10, covering the manifold 46. The manifold adapter is sized and shaped to permit convenient coupling of a pipe, hose or other hydraulic conveyance device to the heat exchanging device 10. The manifold adapter 48 may be attached to the heat exchanging device 10 by a weld, braze or adhesive bond, or any other mechanical means.

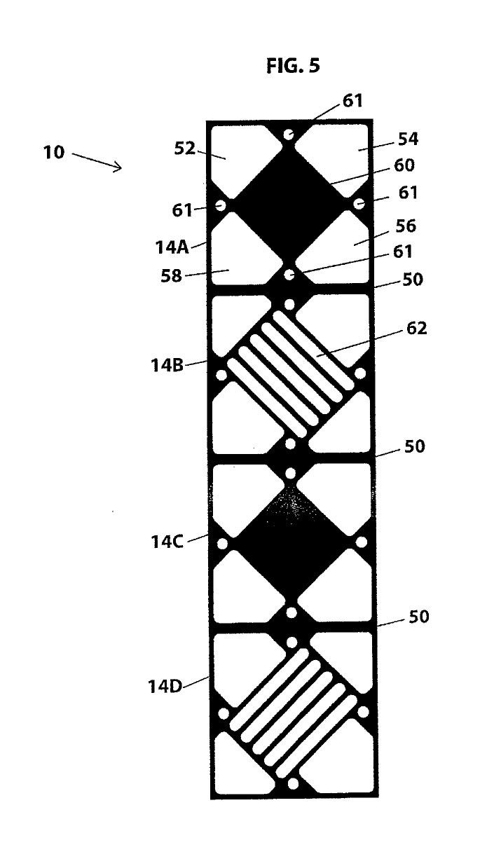

By changing the shape and/or the surface configurations of one or more of the individual subunit elements, the heat exchanging device 10 may assume a variety of shapes with the capability to exchange heat in a variety of fashions. FIGS. 5-13 illustrate multiple embodiments which illustrate the diversity and variety of shapes and functions in which the heat exchanging device 10 can be adapted to perform. Referring to FIGS. 5 and 6, the heat exchanging device 10 is shown having a plurality of different surface configurations within each of the individual subunits and having a different overall shape configuration. One of the unique aspects of the heat exchanging device 10 shown in these figures is the ability to allow multiple fluid flow paths in different directions. Referring specifically to FIG. 5, the heat exchanging device 10 has the same general shape as that illustrated in FIG. 1. The individual subunit elements 14A, 14B, 14C, and 14D, collectively referred as 14, are generally square shaped. Each of the individual subunit elements are linked to adjacent subunit elements through the fold lines 50 which allow the units to be folded in the same manner as described above. Each of the subunit elements 14 contain portions which are adapted to provide fluid flow. Subunit 14A contains a plurality of cut-out portions, or inlet/outlet manifolds 52, 54, 56 and 58 which surround a solid region 60. As described above, multiple paths of fluid flow can be utilized with this configuration. For example, fluid flow can be established through inlet/outlet manifolds 52 and 56. Concurrent fluid flow can be accomplished through inlet/outlet manifolds 54 and 58. The adjacent subunit elements 14B-14D are designed in a similar manner having the same cut-out portions 52, 54, 56 and 58. While the cut-out portions 52, 54, 56 and 58 are shown having 5-sides, any shape or configuration may be used.

For subunit elements 14B and 14D, the solid portion or plate 60 is replaced with a plurality of slots or channels 62 which extend through the subunit element 14B and 14D. As illustrated, the heat exchanging device 10 comprises alternating subunit elements so that subunit element 14C has the same configuration as subunit element 14A and subunit element unit 14D has the same configuration as subunit element 14B. Although not illustrated, the top and/or bottom subunit element may contain a manifold to provide a hydraulic connection to a plurality of passages that are formed by the slots or channels 62, or other voids within the structure. To aid in the flow of fluid, the slots or channels 62 associated with each of the subunit elements that may contain such feature may be orientated in different directions. For example, the subunit element 14B is shown having the slots 62 orientated in a direction which is parallel to openings 52 and 56, i.e. northwesterly to southeasterly direction. The subunit element 14D contains the slots 62 orientated in a direction which is parallel to openings 54 and 58, i.e. northeasterly to southwesterly direction. The length of the slots or channels 62 may be larger than the length of the solid portion or plate 60 so that in the folded or stacked configuration, a portion of the slots or channels 62 extend into the cut-out portions 52, 54, 56 or 58 of the above and/or below positioned subunit element. To aid in alignment, each of the subunit elements may contain one or more openings 61.

Referring to FIG. 6, heat exchanging device 10 is shown having an irregular shape. Unlike the embodiments illustrated in FIGS. 1 and 5, the shape illustrated in FIG. 6 provides the heat exchanging device the capability of being used in areas that require non-uniform or irregularly shaped dimensions. The heat exchanging device 10 has the same functionality as the illustrative embodiments described above. For example, the heat exchanging device 10 comprises a plurality of subunit elements 14A, 14B, 14C, 14D, collectively referred to as 14, each having an irregular shape geometrical pattern. Instead of a fold line as described before, the subunits contain fold points 62 and 64 which connect adjacent subunits and allow for accordion folding as described above. The fold points 62 and 64 allow each of the subunits to fold on top of an adjacent subunit, thereby allowing the heat exchanging device 10 to form a desired shape when all of the subunit elements 14 have been folded against each other.

The subunit elements 14 may contain portions which are adapted to provide fluid flow. For example, subunit element 14A contains a plurality of inlet and or outlet manifolds 66, 68, 70 and 72 which surround a generally centrally positioned solid portion or plate 74. The adjacent subunit element 14B is designed in a similar manner having the same inlet and or outlet manifolds 66, 68, 70 and 72. The solid portion or plate 74 is replaced with a plurality of generally centrally located slots or channels 76. The channels may be constructed to be cut within the surfaces at a partial depth instead of being cut through the surface. As illustrated, the heat exchanging device comprises alternating subunit elements so that subunit element 14C has the same configuration as subunit element 14A and subunit element unit 14D has the same configuration as subunit element 14B. Although not illustrated, the top and/or bottom subunit element may contain a manifold to provide a hydraulic connection to a plurality of passages that are formed by the slots or channels 76, or other voids within the structure.

To produce a cross flow heat exchanger, the slots or channels associated with each of the subunit elements that may contain such feature may be orientated in different directions as described for slots or channels of an alternate layer. For example, the subunit element 14B is shown having the slots 76 orientated in a direction which is parallel to openings 66 and 70, i.e. northwesterly to southeasterly direction. The subunit element 14D contains the slots 76 orientated in a direction which is parallel to openings 68 and 72, i.e. northeasterly to southwesterly direction. To aid in alignment, inspection, or device mounting each of the subunit elements may contain one or more openings 78. Other features to aid alignment, inspection, or device mounting known to one of skill in the art may be used, including tabs.

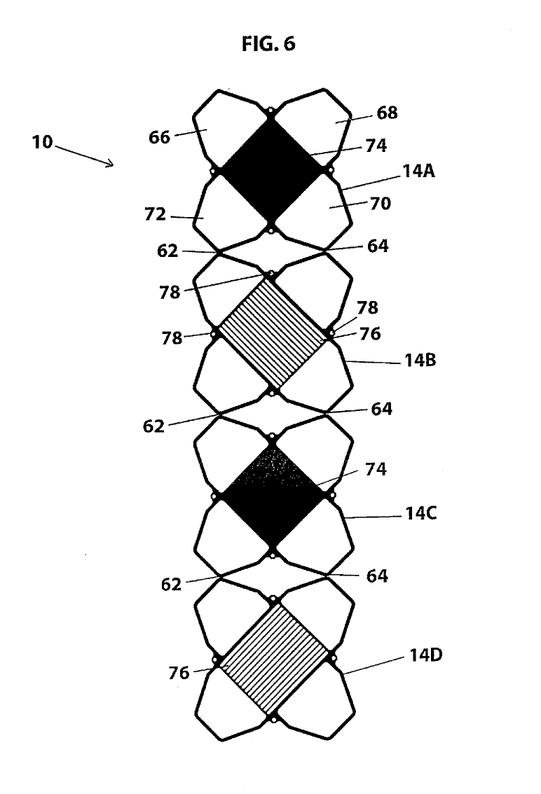

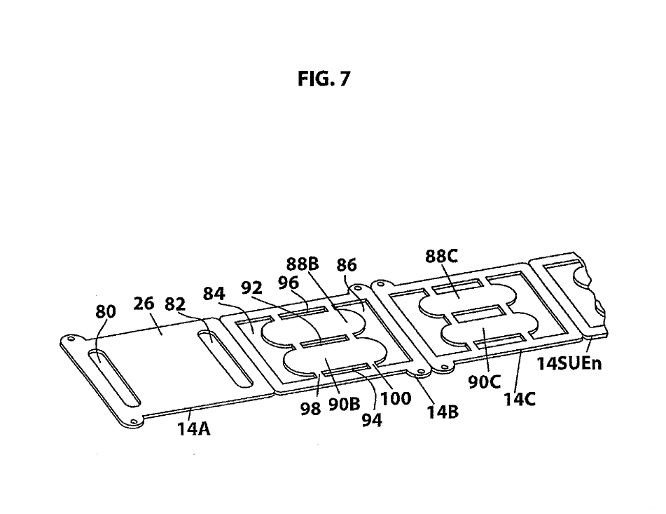

FIGS. 7-9 illustrate an alternative embodiment of the heat exchanging device 10. The heat exchanging device 10 illustrated in FIG. 7-9 is constructed to have any of the same features as described above. The heat exchanging device 10 comprises a plurality of subunit elements, illustrated as three units 14A, 14B, 14C, but collectively referred to as 14. Each of the subunit elements 14 are designed to fold onto adjacent subunit elements to form a particular three-dimensional shape. Subunit element 14A, which forms the top of heat exchanging device 10 when folded, is illustrated comprising two slotted openings 80 and 82 which completely traverses the first surface 26 and the second surface 28 (not illustrated) of the subunit element 14A. The heat exchanging device 10 further comprises a plurality of additional subunit elements 14 that contain other surface configurations that provide regions which allow for fluid flow.

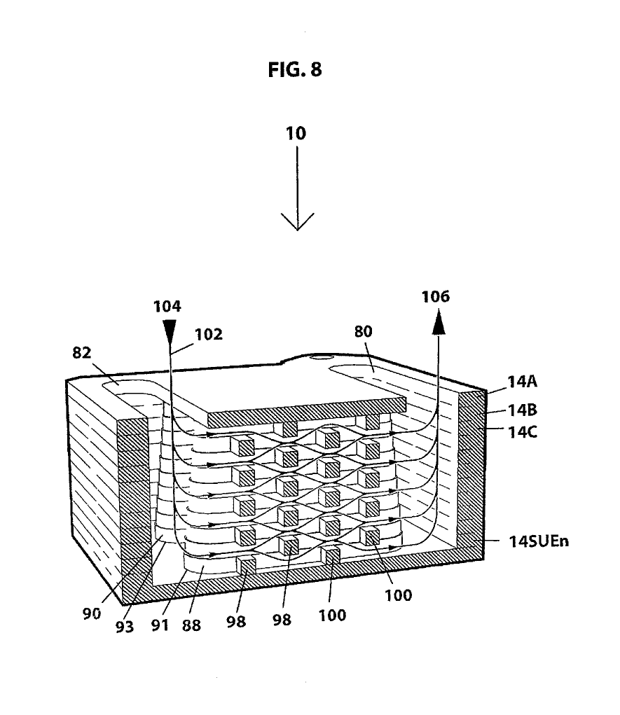

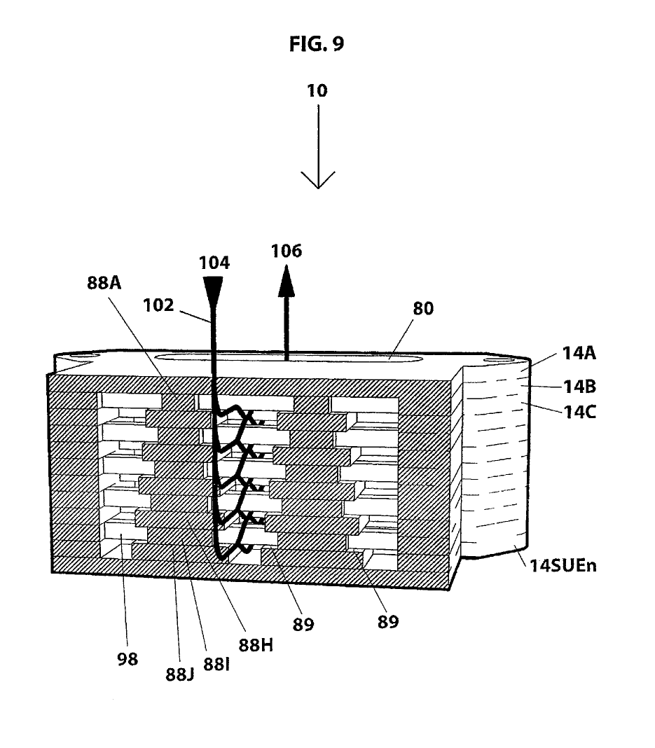

Referring to FIG. 7, the subunit elements 14B and 14C are shown with a plurality of surface configurations in the form of cut out regions 84 and 86 which form generally oval-like shaped plate structures 88B, 88C, and 90B and 90C. Plate structures 88B, 88C, and 90B and 90C when in the stacked configuration, i.e. when subunit 14B is stacked on subunit 14C, form fin structures 88 and 90 (see FIGS. 8 and 9). Fin structures 88 and 90 are illustrated having rounded edges 91 and 93 and shaped with some of the plate structures having different lengths. Such arrangement is illustrative only as the fin structures 88 and 90 may contain plate structures of varied sizes, shapes, and/or thickness. The fin structures 88 and 90 are designed to increase the surface areas by exposing a greater portion of the face, or top and bottom surfaces, of the plate structures with fluid traveling within the heat exchanging device 10. Moreover, the fin structures 88 and 90 may be sized so that the length and/or widths of the plate structures positioned above and below any single plate structure is varied. Such configuration provides fins 88 and 90 having a generally pyramidal shape and/or a staggered arrangement when viewed in cross section, see FIG. 9. Additional surface configurations in the form of cut-out regions 92, 94 and 96 form support structures, illustrated herein as stringers 98 and 100. The stringers 98 and 100 provide lateral support for the fin structures 88 and 90.

FIG. 8 is a section view of the heat exchanging device 10 comprising a plurality of stacked subunit elements as shown in FIG. 7 which have been folded, compressed and bonded to form a generally cube-shaped configuration. FIG. 8 illustrates a preferred, albeit non-limiting illustration of the arrangement of the fin structures 88 and 90 in relation to the stringers 98 and 100. The stringers 98 and 100 of adjacent layers are offset or staggered so that a continuous fluid path 102 through the device may be created. In this configuration, fluid flows into the heat exchanger device 10 along the general path 102 starting at 104 through the manifold opening 82. The fluid flows through heat exchanger device 10 and exits at 106 through manifold opening 80. As illustrated in the Figure, the stringers 98 and 100 extend past the outermost fin structures 88 or 90 and into the exterior wall of the heat exchanger device 10 to provide lateral positioning and support of the fin-like elements. The stringers 98 and 100 can also function as heat transfer enhancing elements to further boost overall device efficiency.

FIG. 9 illustrates an alternate section view of the heat exchanging device 10 illustrated in FIG. 8. As illustrated in this view, the fluid path 102 through the device 10 is clearly evident. The arrangement of the stringers 98 and 100 and/or the fin structures 88 and 90 may be designed to promote turbulence and enhanced heat transfer to the fluid. A significant advantage of the instant invention is the ability to create fin elements that exhibit functionally gradient characteristics. The application of functionally gradient structures permits maximum heat flow efficiency with minimal material use and without the need to expend additional manufacturing effort. An optimized fin structure of this design is no more difficult to manufacture than a fin with a simple and less effective geometry employed in previous designs.

As an illustrative example, individual plate structures having different widths are used to create such a functional gradient. In the structure shown in FIG. 9, it can be seen that the cross-section of the plate structure 88J is greater than the cross-section of the plate structure 88A. As illustrated in the Figure, the width of plate structure 88A is smaller than plate structure 88B. The portion of plate structure 88B that is larger than plate structure 88A forms finlet 89. The width of plate structure 88C is smaller than the width of plate structure 88B. However, as part of the staggered, stair-like configuration, plate structure 88D has a wider width than plate structure 88C. The overhang or wider portion which forms the finlet 89 provides extra surface area for fluid contact. Each of the overhang portions, or finlets 89 can be sized to have the same length as that of the overhang portions above and/or below. For example, finlet 89 corresponding to plate structure 88B would have the same length as an overhang portion 89 associated with plate structure 88D, 88F, 88G, 88J.

Alternatively, the finlet 89 can be sized so that each overhang positioned above and/or below another overhang may be larger, smaller, or combinations thereof. For example, finlet 89 associated with plate structure 88B may be smaller than the finlet associated with plate structure 88D. The finlet associated with the plate structure 88D is smaller than the finlet associated with plate structure 88F, which is smaller than the finlets associated with plate structures 88H or 88J. The fin formed by the stack of laminar, heat exchanging units as illustrated by the stack comprising plate structure 88A and plate structure 88J as well as the other elements sandwiched between plate structures 88A and 88J comprises a functional gradient member. In addition to being able to readily and economically form functional gradient fins, fins of enhanced surface area or other enhanced geometry may be realized. The finlets 89 formed provide increased surface area for greater fluid contact and greater heat transfer. This functional gradient promotes greater heat transfer than a stack of platelets of continuously decreasing width because such arrangement would provide less fluid contact surface area.

The process of the instant invention may also be used to construct heat exchanger cores comprising fins 88 and 90 that are not necessarily contained in a closed hydraulic reservoir. The cores need not contain for example, the outer walled portions (the sealed edges) that define the closed reservoir. The cores are preferably used in applications where heat is conducted to and/or radiated through the surrounding atmosphere. Additionally, these cores may be placed in a chamber or other hydraulic containment means which has been fabricated by a conventional manufacturing process such as deep-drawing, machining, hydroforming or similar suitable processes but which do not necessarily utilize a plurality of laminar elements in its construction.

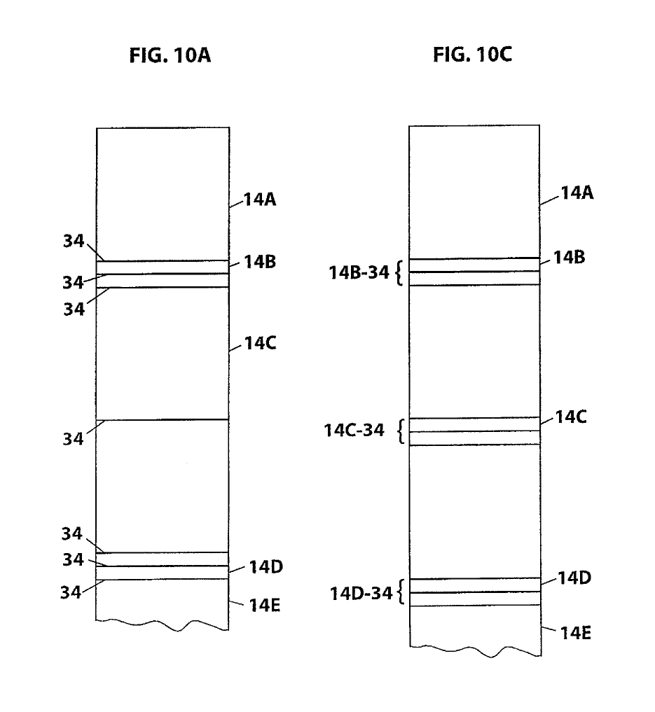

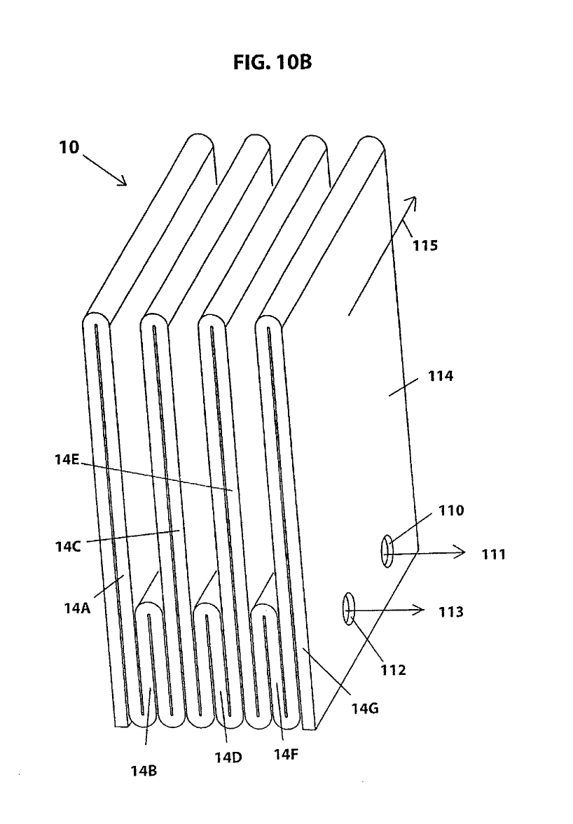

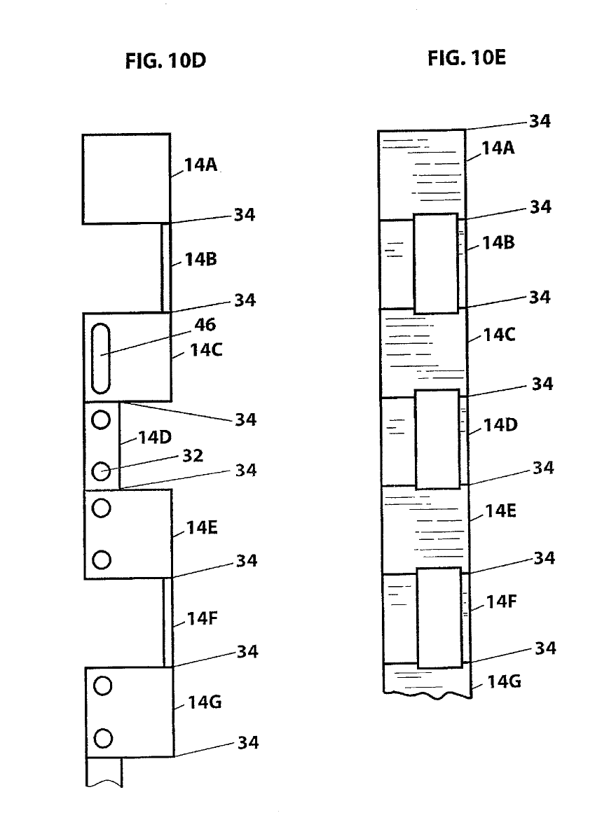

FIGS. 10A and 10B illustrate an alternative embodiment of the heat exchanging device 10 comprising of subunit elements having unequal lengths and/or unequal fold regions. As shown in the Figures, the device 10 contains large subunits, 14A, 14C, 14E, and 14G which alternate with smaller subunits 14B, 14D, and 14F, and fold along fold lines 34 thereby forming a “W” shaped folded pattern. A bridge or loading member (not illustrated) may be secured to the larger subunit elements if needed to prevent collapse of the larger subunit elements. Alternatively, heat exchanging device 10 may contain a large subunit element having double fold lines, see 14C-34 in FIG. 10C, thereby forming a “W” shaped folded pattern within the large subunit so that the bridge member is formed as part of the subunit members. The heat exchanging device 10 contains a first passageway 110 which is used to supply fluids (see arrow 111) in the form of liquids or two phases (gas/liquid) within the device. The first passageway can be formed through each of the smaller subunit members, providing a separate, enclosed passageway for fluid to flow within. A second passageway 112 can be used as a second liquid supply router or as a liquid return (see arrow 113). The large subunit elements may contain a solid surface 114 to allow flow of a fluid, such as but not limited to a gas, represented by arrow 115.

Referring to FIG. 10D, heat exchanging device 10 is shown prior to folding and bonding. In this form of the device a liquid to gas heat exchanger is realized. As illustrated, the device comprises alternating subunit elements 14A, 14B, 14C, 14D, 14E, 14F and 14G. In this example, 14A is a solid (no surface configurations), blank panel and serves as the terminus of the liquid passage formed by the folded combination of apertures 32. Manifold 46 permits fluid flow between the passages and provides a return fluid path so that the first passage may serve as a fluid inlet and the second passage may serve as a fluid outlet. Folding occurs along fold lines 34. The relatively thin elements shown as 14B and 14F as well as 14D function as spacers when the structure is folded. These spacers create gaps between elements 14A, 14C, 14E and so forth essentially creating fins of at least a portion of elements 14A, 14C, 14E, 14G and so forth. Air or other gasses may be forced across these fins to aid in heat dissipation.

FIG. 10E illustrates another form of the device structured to function as a gas cooled heat sink. Elements 14B, 14D and 14F function as spacers as a portion of the subunit element is cut-out, once again, providing a finned structure with fins being formed by elements 14A, 14C, 14E and 14G. The cut-out portions extend past fold lines 34 to provide fluid communication with other areas of the device. The structures illustrated in FIGS. 10D and 10E when folded comprise, an overall shape resembling that illustrated in FIG. 10B having fin portion for heat transfer to or from a gas and a more or less solid portion for heat transfer to or from a liquid or, in the absence of fluid passages, heat transfer to another solid object.

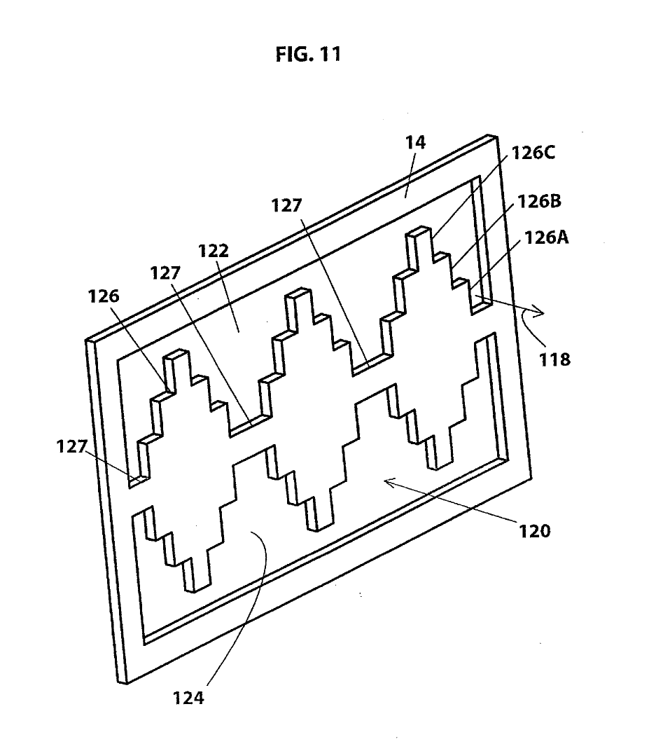

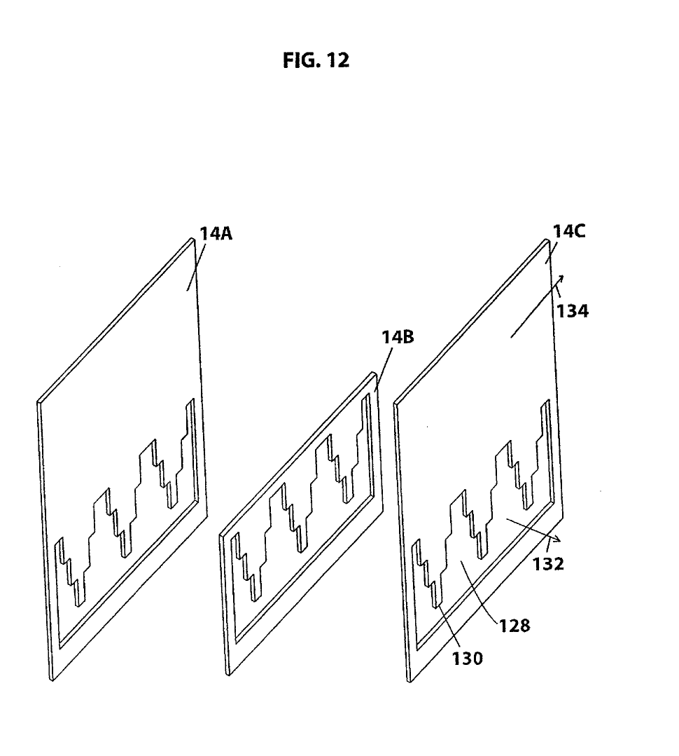

FIGS. 11 and 12 illustrate subunit elements 14 having surface configurations which include removed, or cut-out, portions sized and shaped to act as functional gradients for enhancing fluid flow, decreasing pressure drop and improving heat transfer. Preferably, such subunits align in a vertical manner similar to books stacked on a book shelf. Accordingly, the fold lines can be arranged along any edge or side. The surface configurations formed to act as functional gradients may be constructed having any shape or size which facilitates maximum heat transfer with minimal material and fluid pressure loss. Referring specifically to FIG. 11, the subunit element is adapted for liquid-liquid fluid flow, in a counter flow manner, see arrows 118 and 120, or a parallel flow. The cut-out portions 122 and 124 are configured to form a series of generally triangular patterned shaped structures 126 having a plurality of stepped surfaces. The stepped, generally triangular patterned shaped structures 126 function to increase the surface area responsible for heat exchange as fluid contacts these surfaces. More importantly, the structures 126 contain tapering, having a wide bottom section 126A, a narrow top portion 126C, and gradually narrowing body section 126B. A dividing member, illustrated as dividing bars 127 positioned between the stepped, generally triangular patterned shaped structures 126 and the edges of the subunit 14 may be used to prevent the mixing of the two fluids and support the generally triangular patterned shaped structures during assembly. A fundamental difference between the structure illustrated by FIG. 11 and those previously described is the orientation of the laminar subunits that comprise the structure. In FIG. 11, the generally triangular pattern 126 is fully formed and may be present in a plurality of subunits. End plates (not shown) that do not contain the triangular cut out portions illustrated in FIG. 11 but instead have apertures, are employed to permit fluid flow into and out of the structure.

FIG. 12 illustrates a subunit element 14 which is designed for dual fluid flow, such as gas-liquid flow. A section of the subunit element 14 contains a cut-out portion 128 which forms a series of generally triangular patterned shaped structures 130 having a plurality of stepped surfaces for fluid flow, see arrow 132. The subunit elements 14 also contain a section which is solid, allowing for gas flow, see arrow 134. A fundamental difference between the structure illustrated by FIG. 12 and those previously described is the orientation of the laminar subunits that comprise the structure. Here again, the generally triangular patterned structure 130 is fully formed in the laminar subunit elements 14A, 14B and 14C. By alternately interleaving, preferably by the folding process previously described, a plurality of elements of type 14A and 14B, a structure is formed. In this arrangement, subunit types 14B act as spacers to provide separation between subunit types 14A. The portion of subunit 14A that does not come into contact with subunit 14B becomes fins. The space between the fins permits the passage of a fluid or gas, such as air, to freely pass over the surface of the fins in as illustrated by arrow 134. Since the subunits in this type of assembly may be fabricated from extremely thin laminar material, heat exchangers with exceptionally large fin surface area, and hence, very high efficiency may be created. End plates (not shown) as described with respect to FIG. 11 can be employed to provide liquid flow inlets and outlets to cut-out portion 128.

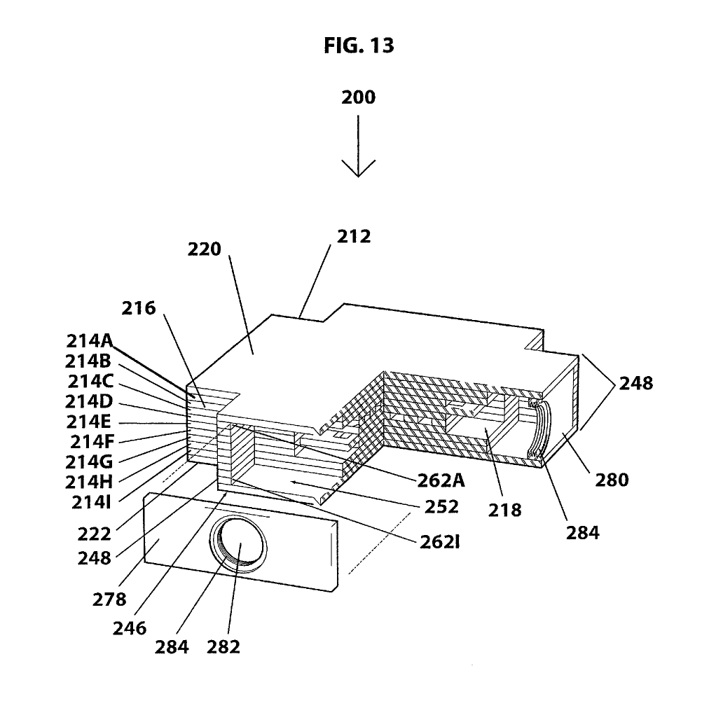

FIGS. 13-15 illustrate alternative embodiments of the heat exchanging device, referred to generally as heat exchanging device 200. The heat exchanging device 200 contains all, or some of the features described previously with added structural features to prevent damage associated with attachment of one or more components to the heat exchanging device 200. The present invention further describes a remote welding process that provides for high temperature welding or brazing for manifold attachment or manifold closure that does not damage the sensitive stack structures associated with the heat exchanging device 200.

The heat exchanging device 200 contains a main body 212, preferably made of a laminar material and/or other materials that exchange heat such as aluminum or copper, comprising individual subunit elements 214A, 214B, 214C, 214D, 214E, and 214F, 214G, 214H, 2141, collectively 214, see FIG. 13. While the illustrative embodiment is shown having nine (9) subunit elements, the heat exchanging device 200 may have fewer or greater than nine. The main body 212 therefore can be defined by the plurality of individual subunit elements, which when folded or stacked form one or more plurality of stacked heat exchanging units. When each subunit elements 214A-2141 is stacked against a subunit above and/or below, depending on the number of subunit elements 214 utilized, an outer edge, surface or wall 216 is formed. As described previously, each of the individual subunit elements 214 may contain surface configurations adapted to allow fluid flow and exchange of heat. The surface configurations are arranged to provide fluid flow pathways, see for example 218. Adjacent subunits may or may not have identical feature patterns as each adjacent subunit need not be unique to its immediate neighbor. In addition, subunit elements 214 may be arranged so that the surface configurations stack to form fluid flow channels and/or heat exchange units having intricate patterns and/or three dimensional shapes.

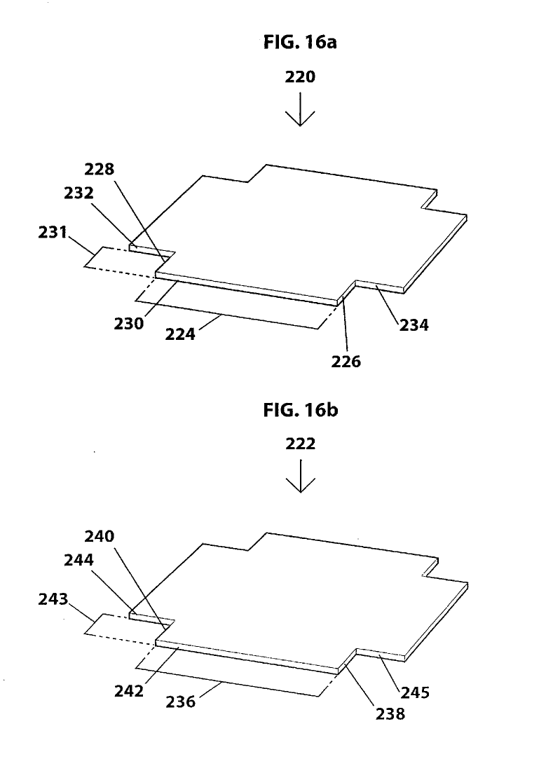

Secured to the upper most subunit element 214A is an upper plate 220. Secured to the lower most subunit element 2141 is a lower plate 222. FIG. 16A illustrates an embodiment of the upper plate 220 having one or more upper plate cantilevered or overhang portions 224. The cantilevered or overhang portions 224 extends away from the outer edge, surface or wall 216 of the heat exchanging device 200 or from each side surface of the subunit elements 214 that define the outer edge, surface or wall 216. As illustrated, the cantilevered or overhang portion 224 comprises a pair of parallel surfaces 226 and 228 separated by a third surface 230 arranged at or near a right angle from the surfaces 226 and 228. The cantilevered or overhang portion 224 also has a depth 231 that extends away from surfaces 232 or 234. Surfaces 232 or 234 preferably align with the outer edge, surface or wall 216.

FIG. 16B illustrates an embodiment of the lower plate 222 having one or more lower plate cantilevered or overhang portion 236. The lower plate cantilevered or overhang portion 236 extends away from the outer edge, surface or wall, 216 of the subunit elements 214. As illustrated, the cantilevered or overhang portion 236 comprises a pair of parallel surfaces 238 and 240 separated by a third surface 242 arranged at or near a right angle from the surfaces 238 and 240. The cantilevered or overhang portion 236 also has a depth 243 that extends away from surfaces 244 and 245. Surfaces 244 and 245 preferably align with the outer edge, surface or wall 216.

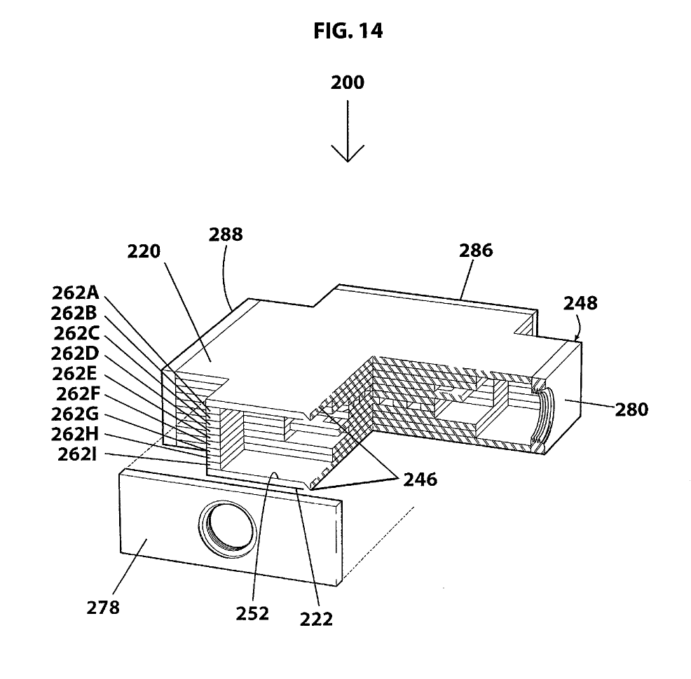

The upper plate cantilevered or overhang portion 224 and the lower plate cantilevered or overhang portion 236 form the upper end and lower end of a heat resistance zone 246, see FIG. 13 or 14. The heat resistance zone 246 can be closed off by a first heat resistance zone wall 248 (also referred to as a wing wall) and an opposing second heat resistance zone wall 250 (not shown) to form an interior region 252. Each of the first heat resistance zone wall 248 and an opposing second heat resistance zone wall 250 is preferably formed by stacking the individual subunit elements 214A-214E so that a wall structure is formed.

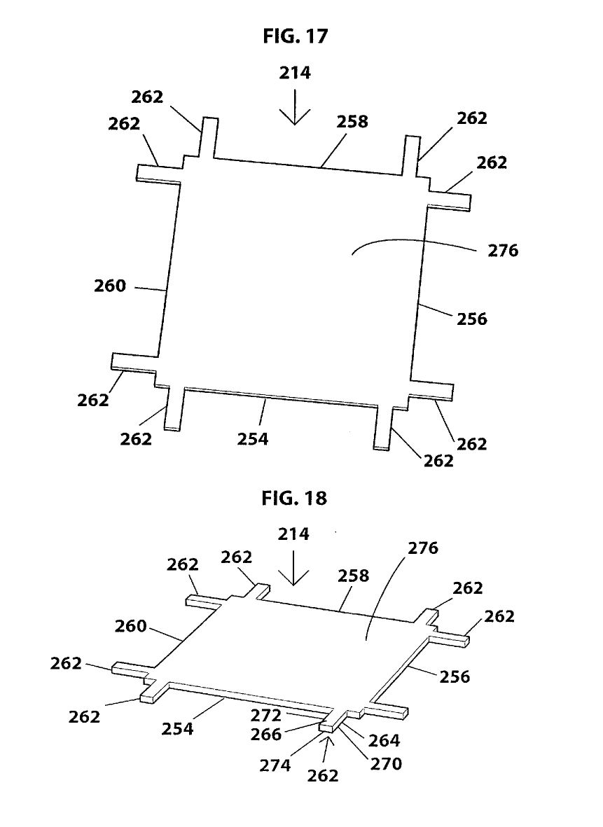

Referring to FIGS. 17 and 18, an illustrative example of a subunit element 214 is shown. The subunit element 214 has a plurality of side edges 254, 256, 258, and 260. The side edges, when sacked with adjacent subunit elements, form the outer edge, surface or wall 216 of the heat exchanging device 200. Emanating from one or more of the side edges 254, 256, 258, or 260 is one or more heat resistance zone wall surface extensions, illustrated herein as appendages or finger-like structures 262. Preferably, the appendages or finger-like structures 262 are created using any technique as described for providing surface configurations such as by punching, machining, fine-blanking, etching, laser cutting, water-jetting, grinding, photo-chemical machining, ion-milling, abrasive blasting or any other suitable process.

Each appendage or finger-like structure 262 comprises a main body 264 comprising a top surface 266, a bottom surface 268 (not shown) and two opposing side walls 270 and 272. The appendage or finger-like structure 262 extends outwardly, away from side edges 254, 256, 258, and 260. At the distal portion, i.e. away from the side edges, is an end plate connecting surface 274. The subunit element 214 is shown comprising two appendages or finger-like structure 262 per each side edge 254, 256, 258, and 260. In this arrangement, the heat resistance zone 246 is formed by a plurality of wing walled sections, each extending away from the main body of the stack. While illustrated as having two appendages or finger-like structures 262 per each side edge, the use of two is illustrative only as each side edge may have additional structures or none. Moreover, each of the appendages or finger-like structures 262 is not limited to a rectangular shape and may take on any shape or configuration as can be designed and manufactured.

In certain embodiments, it is desirable to produce a heat resistance zone wall having tall, thin or long appendages 262. As the ratio of the height and/or the length of the heat resistance zone wall relative to the wall width increases, it becomes increasingly difficult to produce. In some cases, the wall may collapse during the bonding or brazing process, as the individual platelets become displaced laterally from each other. In other cases, the wall may warp or buckle due to thermally induced stresses or under loading applied to facilitate brazing. By proper application of the use of stringers previously described and/or by careful application of removable supports employed during the brazing process, high aspect ratio walls, e.g. ⅛″ wide and as high as 3″ tall can be produced. Walls with such high height to thickness ratio and shorter thin walls can be particularly beneficial in the construction of brazed stacks configured for remote welding.

A heat exchanging device 200 having thin heat resistance zone walls can be employed to produce a more gradual temperature gradient between the part and the weld, and can be employed to isolate the heat from the sensitive portion of the stack. This minimizes problems associated with thermal expansion stresses and chemical or metallurgical reactions in the stack that can result from high temperature, post-bond operations. Because the total heat required to achieve an acceptable weld is minimized in a thin wall section, the thin heat resistance zone wall develops less stress in welding than a thicker part and less heat and stress are transmitted to adjacent parts. A heat resistance zone wall with a remote weld can avoid the “triple point” issue of having to manage welding to three surfaces simultaneously, potentially reducing the number to two. This is particularly important in that the process of welding three joints that meet at a single point can generate extreme stresses at that point. Depending on the welding process, the point where the welds meet is essentially heated at least twice and potentially three times, each time introducing additional stresses and increasing the chance of a damaging metallurgical change.

While the surface 276 of the subunit element 214 is shown without any surface configurations, the lack of such configurations is for illustration purposes only. The heat exchanging device 200 further comprises one or more endplates 278, 280. The end plate 278 is situated away from the main body of the stack and is attached by welding or brazing to one or more portions of the upper plate cantilevered or overhang portion 224, one or more portions of the lower plate cantilevered or overhang portion 236, the first heat resistance zone wall 248 (defined by a plurality of appendages or finger like structure 262A-262I), and the opposing second heat resistance zone wall 250 (defined by a plurality of second appendages or finger like structure 262A-262I, not shown). The end plate 280 may be attached in a manner similar to the attachment means described for end plate 278.

Because the welding process required to attach the end plate 278, 280 to the stack is removed from the region near the main body 212 of the platelet stack, minimal heat is transmitted from the weld area to critical areas of the brazed or diffusion bonded stack thereby sparing the stack from damage modes as described previously. An inlet/outlet port 282 is provided to permit fluid entry/exit, see FIG. 13. The fluid inlet/outlet port 282 may contain internal threading 284 and is sized and shaped to receive inlet/outlet tubing or manifold adapters.

Referring to FIG. 14, the heat exchanging device 200 is illustrated having end plates along each side. In addition to the end plates 278 and 280, the heat exchanging device 200 contains end plates 286 and 288. Endplates 278, 280, 286 or 288 may fit inside the interior region 252 prior to welding or brazing to the upper cantilevered or overhang and lower cantilevered or overhang and the first and second heat resistance zone walls. Alternatively, the end plates fit onto a plane formed with the mutual, distal ends of the upper plate and lower cantilevered or overhand portions and the first and second heat resistance zone walls. To aid in insertion, the end plates may be held in place by a clamp. Alternatively, the distal ends of the upper or lower plates or one or more of the first and second heat resistance zone walls may contain a securing element, such as a tab sized and shaped to hold and maintain the endplates in place until properly secured.

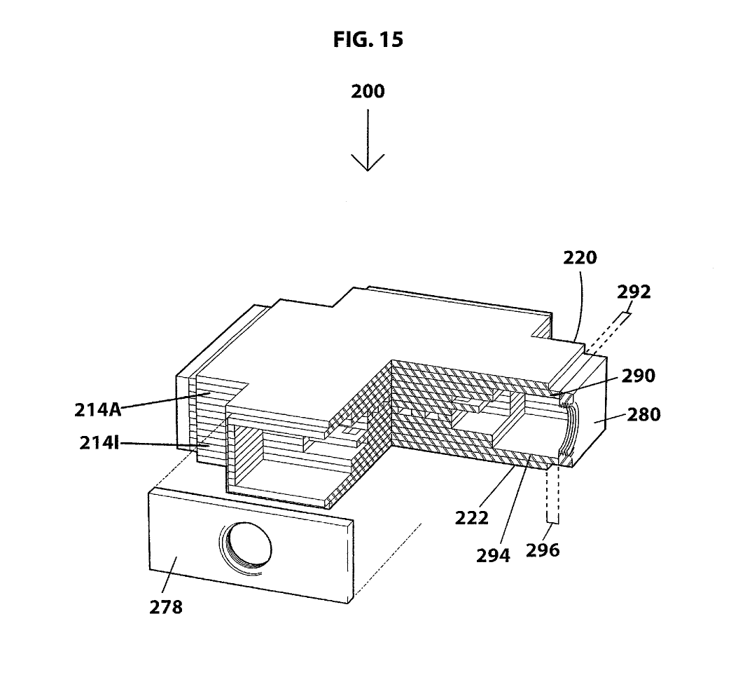

Referring to FIG. 15, the heat exchanging device 200 is shown having incorporated a unique weld feature. Positioned under the upper plate 220 is an upper extension plate 290. The upper extension plate 290 may be constructed to mirror the shape and configuration of the upper plate 220, differing in comprising a portion that extends out past the upper plate 220. The portion of the upper extension plate 290 that extends out past the upper plate 220, referred to generally as an upper extension plate underhang 292 preferably forms part of the heat resistance zone 246. Positioned above the lower plate 222 is a lower extension plate 294. The lower extension plate 294 may be constructed to mirror the shape and configuration of the lower plate 222, differing in comprising a portion that extends out past the lower plate 222. The portion of the lower extension plate 294 that extends out past the lower plate 222, referred to generally as a lower extension plate over hang 296, preferably forms part of the heat resistance zone 246. Portions of the upper extension plate 290 and the lower extension plate 292 can be offset, or formed inwardly from the upper plate 220 and the lower plate 222 to form areas of reduced cross section. Regardless if set inwardly, the use of upper extension plate underhang 292 and the lower extension plate overhang 296 provides an area of reduced cross section as compared to a heat exchanging device 200 which does not utilize the upper extension plate 290 and the lower extension plate 294.

The reduced cross-section permits welds to be made with the application of less heat than would be required for full-thickness members, thereby limiting the potential for heat-induced damage to the stack proper, i.e. the portion of individual subunit element 214 that form fluid flow channels and/or heat exchanging capability. This benefit comes in addition to the benefit of having removed the weld zone(s) from the stack proper and the delicate geometries that may be contained therein. A further benefit of the design shown in FIG. 15 is realized by the fact that the welding of the end plates 278, 280 (and 286 and 288 if used) to the heat resistance zone walls, such as first heat resistance zone wall 248 and the opposing second heat resistance zone wall 250, or cantilevered plates, occurs inside the outer-most surfaces of the heat resistance zone walls or the end plates. Such a design helps to ensure that there will be no welding artifacts that extend above the top upper plate 220, below the lower plate 222 or outside the heat resistance zone walls. This is particularly beneficial if the upper surface of the upper plate 220 and/or the lower surface of the lower plate 222 are to be mated to flat surfaces of, for example, a semiconductor heat sink, which might extend beyond the peripheral edges of the upper plate 220 or the lower plate 222.

The heat exchanging device 200 may be constructed using any techniques and include one or more features described herein, including those described for the various heat exchanging embodiments described throughout. In an illustrative embodiment, a method of constructing a heat exchanging device formable into a predetermined configuration adapted to minimizes damage to the internal structure when adding a manifold attachment or manifold port, comprising the steps of providing or manufacturing a plurality of individual components which when stacked together form a shape. The individual components can be formed to include surface configurations or are provided with pre-made surface configurations which determine a fluid flow pathway. Accordingly, at least one of the plurality of individual components contain one or more surface configurations adapted to allow one of fluid flow or exchange of heat and to provide at least a portion of a heat resistance zone. The surface configurations may be formed by various techniques known to one of skill in the art, including, but not limited to forming by punching, machining, fine-blanking, laser cutting, water-jetting, grinding, photo-chemical machining, ion-milling, or abrasive blasting.

Once the individual components contain the desired surface configurations, two or more individual components are stacked to form a heat exchanging unit having at least a main body and at least one side edge. The two or more individual components are arranged so that when adjacent units are joined, the surface configurations are aligned to form a pre-determined shape or structure. At least one heat resistance zone is formed, preferably by providing individual elements having, or being constructed to have, a second set of surface configurations, such as the individual subunit having appendages 262, as illustrated FIG. 17 or 18 and described herein. As such, the individual components are arranged so that when adjacent individual components are stacked, a heat resistance wall is formed, having a desired length, height, and thickness. Preferably, the length of the heat resistance wall extends a predetermined distance from at least one side edge of said main body of the heat exchanging device. An upper plate and a lower plate having overhang areas as described above are secured to portions of the main body to provide a partially enclosed area. The partially enclosed area provides a heat resistance zone which provides for remote weld surfaces defined as surfaces that can be used to weld additional components, such as one or more end plates, at a position remote or away from the heat exchanging main body. As such the heat resistance zone has opposing side walls, a top wall, a bottom wall, and an interior space. One or more end plates are remotely welded and secured to one or more portions of the heat resistance zone, which when secured thereto, enclose the heat resistance zone. Additional extension plates may be provided or manufactured and secured under the upper plate and on top of the lower plate.

In addition to the advantages enumerated previously, the issue of cracking in materials in which phosphorus is present can be minimized by application of the remote welding process described herein. Certain nickel based brazing alloys often contain a small percentage of phosphorus. It is not uncommon for phosphorus to be present in quantities of up to 11% in some braze alloys. The phosphorus serves as a melting point depressant and facilitates the brazing process. However, when these alloys are subjected to the high heat of the welding processes, cracking frequently occurs. The use of the remote welding process can alleviate this problem in many ways. First, the high heat of the welding process can be removed from the most sensitive and complex portion of the main body or stack proper. Second, most of the weld-induced cracking occurs as a result of the extreme heating and cooling rates involved during the process, which leads to severe thermal expansion differences within the part. The wing walls serve as compliant members accommodating thermally induced stresses. Finally, the main body or stack proper, exclusive of the wing walls, essentially serves as a reservoir of the melting point depressant more so than the wing walls. This is because the micro-channels are transient liquid phase coated and the wing walls do not contain micro-channels. As such, they have significantly less of the melting point depressant. Additionally, the wing walls heat more quickly than the balance of the stack and the melting point depressant that is present will have a longer time to diffuse to a lower concentration. In the instance where the joining process does not depend on transient liquid phase, this mechanism is not present.

Welding access points and manifold geometry are no longer defined by the edges of the stack proper but are designed as an integral part of the stack. This allows weld preparation features to be purposely incorporated into the stack prior to the actual welding process and avoids using a post-bond machining process that might introduce contaminants into the device being fabricated. These weld preparation features are removed from the vicinity of the stack body such that attachment of manifolds by welding or brazing will not introduce unacceptable stresses, chemical, or metallurgical reactions to the bonded stack. Specifically, incorporation of stack face sheets that extend beyond (overhang) the main stack body eliminate the necessity of making a weld immediately adjacent to the sensitive stack body. Additionally, any mechanical attachment such as a threaded fastener or rivet may be made remotely and safely away from the main stack.

Because the process of the instant invention permits the potentially damaging high heat process of welding to be removed from the sensitive portions of the stack, a great deal of freedom may be enjoyed in the stack design. This freedom can include finer geometries of members and fluid passages, more delicate overall structures, and the creation of structures that would otherwise be impossible to avoid damaging during the manifold welding process of previous designs. This allows the stack to be manufactured with a highly beneficial manifold created during the processing step used for the manufacture of the stack. This process can eliminate manufacturing steps, provide a stronger and more robust manifold, and result in more efficient operation of the device through improved hydrodynamic performance. Independent of whether transient liquid phase or bare-bonding or conventional brazing is used to join stack components, it is important in wash-coating operations that an open manifold be used to assure that uniform coatings are achieved. Uniform coatings are difficult to create with no manifold as is used as well as when a closed face manifold is used. The wing walls created as a part of the assembly reduce the need for a temporary wall structure/manifold.

Because the individual component or platelet and face sheet extension features can occupy less space than a traditionally applied manifold, especially complex devices and manifolds that would be impossible to produce without sacrificing device performance can be produced using the method of the invention. Additionally, access points and manifold geometries are no longer defined by the edges of the stack proper, but are instead purposefully and functionally designed as an integral part of the stack. Therefore, less access room will be required for welding, thereby enabling production of more compact and efficient devices.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of preparing a heat exchanging device adapted to permit attachment of a manifold inlet and outlet port at a distance from internal structures of the heat exchanging device thereby minimizing damage to the internal structure comprising the steps of:
providing a plurality of individual components which when stacked together form a shape, at least one of said plurality of individual components contain one or more surface configurations adapted to allow one of fluid flow or exchange of heat and one or more surface extensions adapted to provide at lest a portion of a heat resistance zone;
stacking said individual components to form a heat exchanging unit having a main body and at least one side edge; and
forming at least one heat resistance zone having at least one surface located at a distance from said main body.

2. The method of preparing a heat exchanging device according to claim 1 further including providing an upper plate comprising at least one portion sized and shaped to extend away from said main body, and aligning said upper plate with said main body to form an upper portion of said heat resistance zone.

3. The method of preparing a heat exchanging device according to claim 2 further including providing a lower plate comprising at least one portion sized and shaped to extend away from said main body, and aligning said lower plate with said main body to form a lower portion of said heat resistance zone.

4. The method of preparing a heat exchanging device according to claim 3 further including the step of securing at least one end plate having an opening sized and shaped to receive an inlet or outlet tube to an end surface of said at least one heat resistance zone.

5. The method of preparing a heat exchanging device according to claim 4 further including the step of aligning one or more surface configuration of at least one of said individual components with a surface configuration of at least a second individual component, whereby stacking of said at components forms a fluid flow channel.

6. The method of preparing a heat exchanging device according to claim 5 wherein said a fluid flow channel forms a three dimensional shape.

7. The method of preparing a heat exchanging device according to claim 4 wherein said plurality of individual components are provided as a row of connected components separated by a fold line.

8. The method of preparing a heat exchanging device according to claim 4 wherein said surface configurations are formed by punching, machining, fine-blanking, laser cutting, water-jetting, grinding, photo-chemical machining, ion-milling, or abrasive blasting.

9. The method of preparing a heat exchanging device according to claim 4 wherein said plurality of plurality of individual components are stacked against adjacent individual components via a Z-shaped pattern until a pre-determined shape is obtained.

10. The method of preparing a heat exchanging device according to claim 4 wherein said plurality of individual components comprise of a laminar material.

11. The method of preparing a heat exchanging device according to claim 4 wherein said plurality of individual components are made from a material that exchanges heat.

12. The method of preparing a heat exchanging device according to claim 11 wherein said material that exchanges heat is aluminum, copper, or stainless steel.

13. The method of preparing a heat exchanging device according to claim 4 wherein said one or more surface extensions adapted to provide at least a portion of a heat resistance zone are appendages, said appendages adapted to form side walls of said heat resistance zone when stacked with like-shaped individual components.

14. The method of preparing a heat exchanging device according to claim 4 further including the step of forming heat resistance zones at a distance from two or more side edges of said main body.

15. The method of preparing a heat exchanging device according to claim 4 further including the step of securing each said plurality of individual components to an adjacent individual component.

16. The method of preparing a heat exchanging device according to claim 15 further including the step of securing each said plurality of individual components to an adjacent individual component using chemical mechanisms.

17. The method of preparing a heat exchanging device according to claim 15 further including the step of securing each said plurality of individual components to an adjacent individual component using diffusion bonding, brazing, or welding.

18. The method of preparing a heat exchanging device according to claim 4 further including the step of securing a manifold adapter or tube to said end plate having an opening.

19. The method of preparing a heat exchanging device according to claim 18 wherein said step of securing a manifold adapter or tube to said end plate having an opening includes applying heat to the area defined by said wing wall.

20. A heat exchanging device comprising:
a plurality of individual heat exchanging components which when stacked together form a main body; at least one of said plurality of individual heat exchanging components having at least a first surface configuration adapted to allow one of fluid flow or exchange of heat and one or more surface extensions which forms a portion of a heat resistance zone;
a heat resistance zone having at least one welding surface located at a distance from said main body;
an upper plate comprising at least one portion sized and shaped to extend away from said main body; said upper plate aligned with said main body to form an upper portion of said heat resistance zone;
a lower plate comprising at least one portion sized and shaped to extend away from said main body, said lower plate aligned with said main body to form a lower portion of said heat resistance zone;
and one or more end plates, said end plates having a manifold inlet or outlet port sized and shaped to engage a manifold adapter or tube.
